(19) United States
(12) Patent Application Publication
(10) Pub. No.: US 2001/0009321 A1
(43) Pub. Date: Jul. 26, 2001

(54) Mounting structure for suspension V-rod

(75) Inventors: Kazuo Toyoshima, Tokyo (JP); Yoshiyuki Koga, Tokyo (JP)

Correspondence Address: OBLON, SPIVAK, McCLELLAND, MAIER & NEUSTADT, P.C., Fourth Floor, 1755 Jefferson Davis Highway, Arlington, VA, 22202, US

(73) Assignee: HINO MOTORS, LTD., Tokyo (JP)

(21) Appl. No.: 09/740,861

(22) Filed: Dec. 21, 2000

(30) Foreign Application Priority Data
Jan. 25, 2000 (JP) 2000-015899

(51) Int. Cl. F16M 13/00

(52) U.S. Cl. 280/86.75; 248/610

(57) ABSTRACT

Disclosed is a mounting structure for a suspension V-rod which can establish firm connection of a V-rod to an axle by fastening with unexcessive proper torque. Ends of an oscillating pin carried by a central bent end of the V-rod are aligned with brackets on a center of the axle and are fastened to the latter by a plurality of pairs of bolts and nuts. At least one pair of bolt and nut among the bolt and nut pairs and a bolt hole mating with the one pair are tapered such that a bold head of the bolt and the nut have tapered portions formed on opposed end faces thereof and gradually decreasing in diameter toward each other and that the mating bolt hole is complementarily tapered to snugly receive the tapered bolt head and the tapered nut.

### BACKGROUND OF THE INVENTION

The present invention relates to a mounting structure for a suspension V-rod for use in a large-sized motor vehicle such as a truck or a bus.

FIGS. 1 and 2 show a conventional rear suspension structure in a motor vehicle such as a large-sized truck having two rear wheel axles. In the structure shown, an axle 3 is arranged under a pair of right and left frames 1 which extend along the front-rear direction (the left-to-right direction in FIG. 1) or longitudinally of a vehicle body. The axle 3 extends widthwise or laterally of the vehicle body (the top-bottom direction in FIG. 2) to rotatably support wheels 2 at opposite ends of the axle 3. The axle 3 has support beams 4 integrally assembled to a lower surface of the axle 3 adjacent the ends of the axle 3. Front and rear air springs 5 for absorbing vertical vibrations are interposed between front and rear ends of the support beams 4 and undersurfaces of the frames 1, respectively.

Brackets 6 extending downward are mounted on the frames 1 forwardly of the front air springs 5. Lower ends of the brackets 6 are tiltably connected to intermediate portions of the support beams 4 through lower torque rods 7 which also serve as stabilizers for enhancing anti-roll rigidity of the vehicle body.

Intermediate portions of the lower torque rods 7 are connected to the frames 1 directly thereabove through vertically extending shock absorbers 8, so that the shock absorbers 8 suppress vertical vibration rebounds to achieve vibration damping.

As clearly seen from FIG. 2, a top center of the axle 3 is connected to inside surfaces of the flames 1 through a V-rod 9 which serves as upper torque rod. More specifically, branched front ends 9a of the V-rod 9 are connected to brackets 10 extending from the inside surfaces of the frames 1. A rear, central bent end 9b of the V-rod 9 is connected to brackets 11 on the top center of the axle 3.

FIGS. 3 and 4 show details of the bent end 9b of the V-rod 9 connected to the axle 3. The bent end 9b carries an oscillating pin 15 extending therethrough; the pin 15 is oscillatably held at its spherical center portion 13 via a rubber bush 12 by the bent end 9b of the V-rod 9 as a hub. The pin 15 has opposite ends 14 extending outward and laterally of the vehicle body. The ends 14 of the pin 15 are aligned with and fastened to rear surfaces of the brackets 11 on the axle 3 by a plurality of pairs (two pairs, in the shown example) of bolts 16 and nuts 17 longitudinally of the vehicle body.

The branched ends 9a of the V-rod 9 are connected to the frames 1 in a manner substantially similar to the above-described connection of the bent end 9b of the V-rod 9 to the axle 3, except for difference in shape of the mating parts or brackets 10 to be connected. Accordingly, description thereon will be omitted.

Adoption of such V-rod 9 will contribute to coping with any inputs both longitudinally and laterally of the vehicle body. This eliminates the necessity for those lateral rods against any lateral inputs which may be required in a case where parallel-link-type torque rods are adopted.

However, such a conventional suspension structure with a V-rod is disadvantageous in that lateral inputs, which will act in parallel with those bearing surfaces of the ends 14 of the pin 15 and of the brackets 11 against which heads 16a of the bolts 16 and the nuts 17 are pressed, tend to cause lateral slips on the bearing surfaces, resulting in drop of the fastening forces.

More specifically, shanks 16b of the bolts 16 are inserted to bolt holes 18 drilled through the ends 14 of the pin 15 and brackets 11. To ensure insertion of the shanks 16b of the bolts 16 to the bolt holes 18, the bolt holes 18 have to be made slightly greater than the shanks 16b of the bolts 16. This inevitably entails slight gaps between the bolt holes 18 and the shanks 16b of the bolts 16, and hence the respective bearing surfaces of the ends 14 of the pin 15 and of the brackets 11 may undergo lateral slips depending upon the slight gaps.

Conventionally, such lateral slips may only be reduced by increasing frictional forces on the bearing surfaces. Therefore, in order to minimize the lateral slips generated depending upon bearing surface conditions, excessive fastening forces are required for the bolts 16 and nuts 17. This may lead to troublesome torque control in the fastening of the bolts 16 and nuts 17, resulting in great hindrance in obtaining high maintainability.

The invention was made in view of the above and has its object to provide a mounting structure of a suspension V-rod which can establish firm connection of the V-rod to an axle merely by fastening with unexcessive proper torque, so that drop of the fastening force due to lateral slips on the bearing surfaces can be avoided and higher maintainability than heretofore can be obtained.

### BRIEF SUMMARY OF THE INVENTION

The invention provides a mounting structure of a suspension V-rod which connects a center of an axle to right and left frames, comprising an oscillating pin having a central portion oscillatably held by a central bent end of the V-rod as a hub, said pin having opposite ends extending outward and laterally of a vehicle body, brackets on the center of the axle, said ends of the pin being aligned with the brackets longitudinally of the vehicle body, and a plurality of pairs of bolts and nuts for fastening the ends of the pin to the brackets longitudinally of the vehicle body, at least one pair of bolt and nut among said plurality of pairs of bolts and nuts and the bolt hole mating with said at least one pair being tapered such that a bold head of the bolt and the nut have tapered portions formed on opposed end faces thereof and gradually decreasing in diameter toward each other and that the mating bolt hole is complementarily tapered to snugly receive said tapered bolt head and said tapered nut.

Accordingly, when the ends of the oscillating pin carried by the V-rod are fastened to the brackets on the axle by the bolts and nuts, said at least one pair of bolt and nut are snugly received at their tapered portions by the complementarily tapered bolt hole, respectively, with no gap. Thus, simply applying unexcessive proper torque to the bolts and nuts provides high fastening strength due to a wedge effect of the tapered pair of bolt and nut with the mating bolt hole.

The tapered inner peripheries or portions of the mating bolt hole provides bearing surfaces for the tapered portions of the tapered bolt and nut, respectively. As a result, the tapered portions of the tapered bolt and nut are interfered with the tapered bearing surfaces of the bolt hole, respectively, so that any inputs laterally of the vehicle body are received with reliability. This prevents any disadvantageous lateral slips due to lateral inputs from being generated on the bearing surfaces.

Adoption of such a lateral-slip preventive structure using no frictional force will eliminate the necessity for the bolts and nuts to be tightened or fastened under excessive forces. Therefore, it becomes possible to establish firm connection of the V-rod to the axle by merely applying proper torque.

A preferred embodiment of the invention will be described with reference to the drawings.

### BRIEF DESCRIPTION OF THE DRAWINGS

FIG. 1 is a side view showing a conventional rear suspension structure;

FIG. 2 is a view looking in the direction of arrows II in FIG. 1;

FIG. 3 is an enlarged view partly in section of FIG. 2;

FIG. 4 is a perspective view of FIG. 3; and

FIG. 5 is a plan view partly in section showing an embodiment of the invention.

### DETAILED DESCRIPTION OF THE PREFERRED EMBODIMENT

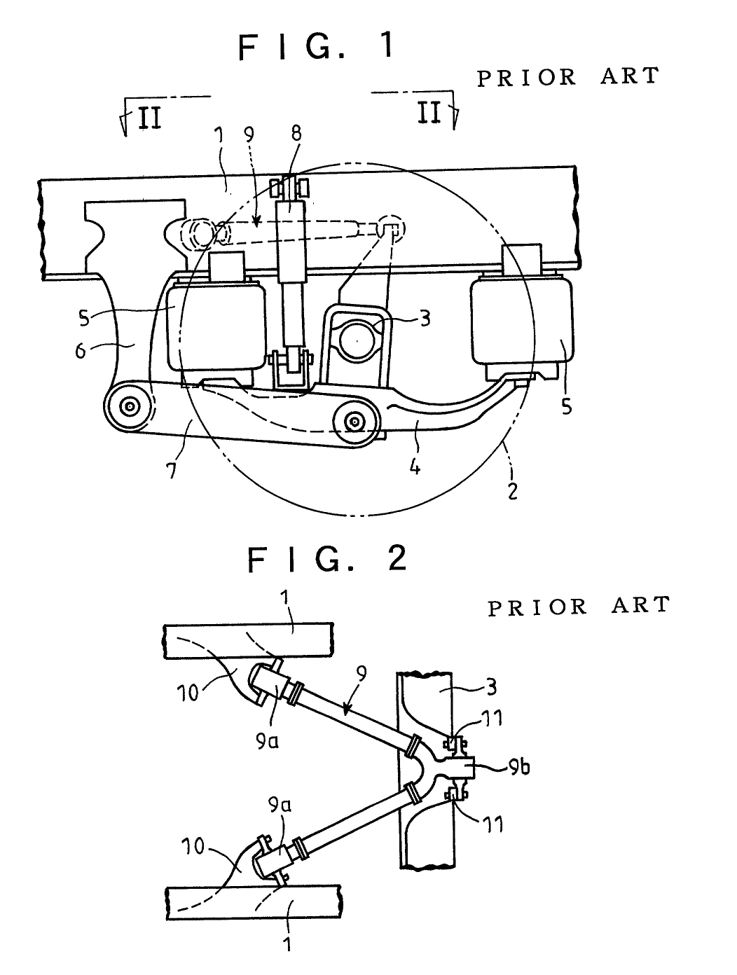

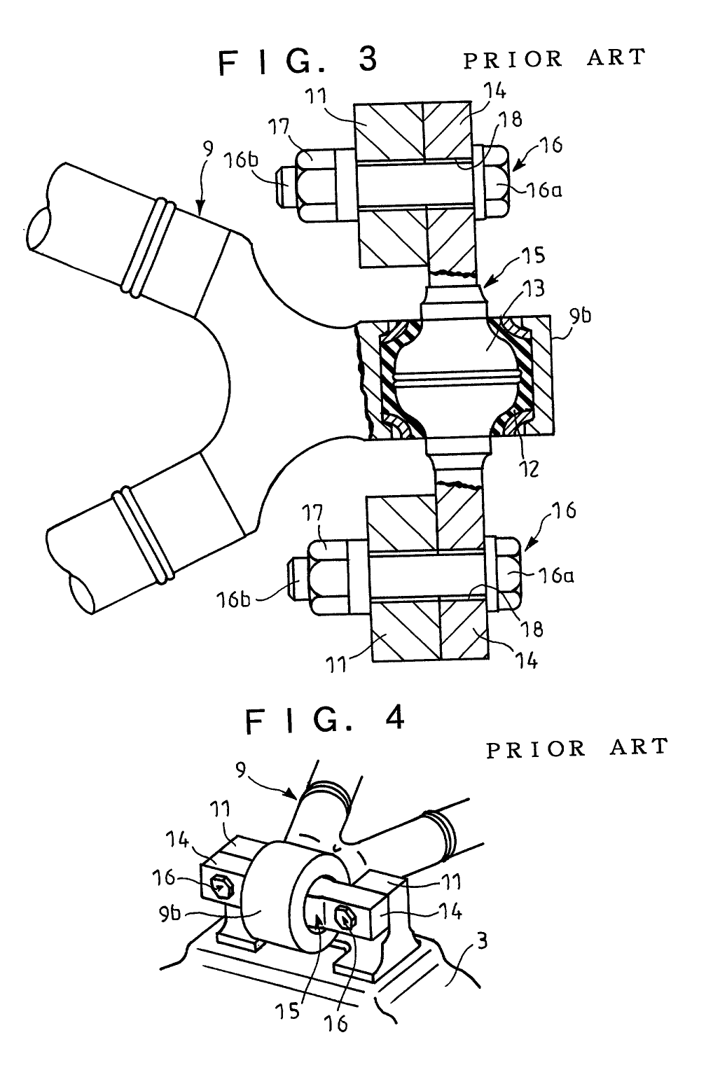

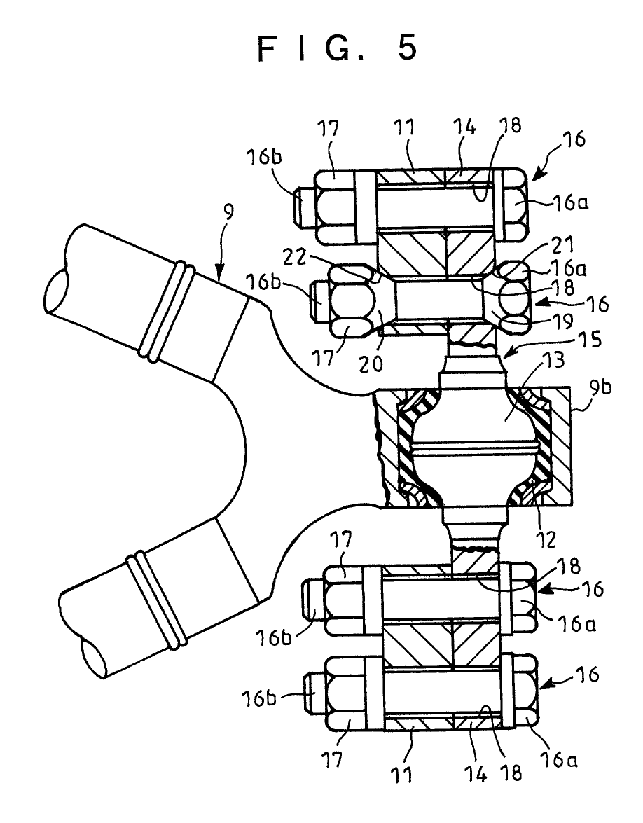

FIG. 5 is a view showing an embodiment of the invention in which reference numerals identical to those in FIGS. 1-4 represent the same parts.

In the embodiment shown, a mounting structure of a suspension V-rod 9 which connects a center of an axle 3 to right and left frames 1 comprises an oscillating pin 15 held by a bent end 9b of the V-rod 9, brackets 11 on a top center of the axle 3, ends 14 of the pin 15 being aligned with the brackets 11 longitudinally of a vehicle body, and a plurality of pairs of bolts 16 and nuts 17 for fastening the ends 14 of the pin 15 to the brackets 11. Among the pairs of bolts 16 and nuts 17, at least one pair of bolt 16 and nut 17 are configured as detailed below.

More specifically, in the embodiment shown, two pairs of bolts 16 and nuts 17 for each end 14 of the pin 15, that is, totally four pairs of bolts 16 and nuts 17 are used to fasten the pin 15 to the brackets 11 on the axle 3. Among these pairs of bolts 16 and nuts 17, a pair of bolt 16 and nut 17 are tapered such that a head 16a of the bolt 16 and the nut 17 have tapered portions 19 and 20, respectively, formed on their opposed end faces and gradually decreasing in diameter toward each other. Moreover, a bolt hole 18 mating with the tapered bolt 16 and nut 17 has, at its ends, tapered portions 21 and 22 complementary to the tapered portions 19 and 20 of the bolt 16 and nut 17, respectively.

Accordingly, when the ends 14 of the pin 15 carried by the V-rod 9 are fastened to the brackets 11 on the axle 3 by the bolts 16 and nuts 17, the tapered portions 19 and 20 of the pair of tapered bolt 16 and nut 17 are snugly received by the tapered portions 21 and 22 of the tapered bolt hole 18, respectively, with no gap. Thus, simply applying unexcessive proper torque to the bolts 16 and nuts 17 provides high fastening strength due to a wedge effect of the tapered pair of bolt 16 and nut 17 with the mating bolt hole 18.

The tapered inner peripheries or portions 21 and 22 of the mating bolt hole 18 provides bearing surfaces for the tapered portions 19 and 20 of the tapered bolt 16 and nut 17, respectively. As a result, the tapered portions 19 and 20 of the tapered bolt 16 and nut 17 are interfered with the tapered bearing surfaces 21 and 22 of the bolt hole 18, respectively, so that any inputs laterally of the vehicle body are received with reliability. This prevents any disadvantageous lateral slips due to lateral inputs from being generated on the bearing surfaces.

Adoption of such a lateral-slip preventive structure using no frictional force will eliminate the necessity for the bolts 16 and nuts 17 to be tightened or fastened under excessive forces. Therefore, it becomes possible to establish firm connection of the V-rod 9 to the axle 3 by merely applying proper torque.

Thus, according to the embodiment described above, mere tightening or fastening with unexcessive proper torque will establish firm connection of the V-rod 9 to the axle 3 and avoid generation of lateral slips on the bearing surfaces for the heads 16a of the bolts 16 and the nuts 17. This can avoid drop of the fastening force due to lateral slips on the bearing surfaces and facilitate the torque control to drastically improve maintainability.

It is to be understood that the inventive mounting structure of a suspension V-rod is not limited to the above embodiment and that various changes and modifications may be made without departing from the scope and spirit of the invention. For example, two or more pairs of bolts and nuts and bolt holes mating therewith may be tapered.

What is claimed is:

1. A mounting structure of a suspension V-rod which connects a center of an axle to right and left frames, comprising an oscillating pin having a central portion oscillatably held by a central bent end of the V-rod as a hub, said pin having opposite ends extending outward and laterally of a vehicle body, brackets on the center of the axle, said ends of the pin being aligned with the brackets longitudinally of the vehicle body, and a plurality of pairs of bolts and nuts for fastening the ends of the pin to the brackets longitudinally of the vehicle body, at least one pair of bolt and nut among said plurality of pairs of bolts and nuts and the bolt hole mating with said at least one pair being tapered such that a bold head of the bolt and the nut have tapered portions formed on opposed end faces thereof and gradually decreasing in diameter toward each other and that the mating bolt hole is complementarily tapered to snugly receive said tapered bolt head and said tapered nut.
